(19) United States
(12) Patent Application Publication
(10) Pub. No.: US 2010/0199350 A1
(43) Pub. Date: Aug. 5, 2010

(54) Federated Scanning of Multiple Computers

(76) Inventors: Mark David Lilibridge, Mountain View, CA (US); Evan R. Kirshenbaum, Mountain View, CA (US); Craig A. Soules, San Francisco, CA (US); George Forman, Port Orchard, WA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/365,792

(22) Filed: Feb. 4, 2009

(51) Int. Cl. G06F 21/00; G06F 9/46

(52) U.S. Cl. 726/24; 718/105

(57) ABSTRACT

A data processing apparatus and associated computer-executed method are adapted for federated scanning of multiple computers. The data processing apparatus comprises a logic that controls scanning among a plurality of data objects distributed among a plurality of distributed electronic data storage systems. The logic maintains a data set of paired location identifiers and intrinsic references corresponding to individual data objects of the plurality of data objects and controls scanning so that redundant scanning of duplicate data objects with matching intrinsic references occurring in multiple locations is avoided.

### BACKGROUND

Many applications are performed by scanning the local disks of a number of computers. For example, avoiding software viruses is achieved by scanning personal computers (PCs) for viruses. Malware, such as viruses, adware, spyware, and versions of software known to be detrimental to smooth running of a network or computer, is a constant threat to users. For protection against malware, malware scanning software is typically loaded onto user computers. Typically, scanning software on a user computer is scheduled to run at predefined scheduled scan times. The scanning software then scans storage media of the computer in which the scanning software is running. The scanning software can also be run manually upon user request. If malware is found, the scanning software alerts the users and (automatically or upon user confirmation) quarantines or deletes the malware or repairs the file in which the malware is found.

Actions such as litigation-based eDiscovery requests, information worker document searches, and IT utilization trending currently take significant time and effort on the part of users and administrators. Unstructured information management is an emerging area of research dedicated to automating as much and as many of these tasks as possible. Information management solutions typically rely on the ability to scan the contents and activity on unstructured information stores across the enterprise (e.g., desktops, laptops, file servers, SharePoint sites, email servers) to extract structured metadata describing the data. Examples of metadata include content hashes, term vectors, similarity fingerprints, feature vectors, usage statistics, and so forth. Unfortunately, such scanning interferes with the performance of the computers being scanned. Despite constant increases in hardware performance, the combination of the techniques can burden even a modern computer system.

The traditional solution to scanning computers is to independently run one scan on each of the computers with data to be scanned, resulting in detrimental impact on computer performance and wasted work as the same item on different computers is scanned multiple times. Scanning software is resource-intensive and consumes valuable processing and storage media bandwidth. When the scanning software is active, a noticeable slowdown of processing of other software applications in the computer usually occurs. Also, execution of the scanning software can drain the battery of a portable computing device and cause wear and tear on disk-based storage media. As the sizes of storage media increase, scan times for scanning such storage media also increase. Also, since new malware is constantly appearing, malware signatures have to be constantly updated to ensure proper protection against malware. For users who are not connected to a network (and thus are unable to retrieve updated signatures of new malware), adequate protection by scanning software may be deficient. Moreover, as signatures for new malware are received, another round of lengthy scanning has to be performed whenever new malware arrives. Also, to avoid the noticeable slowdown caused by malware scanning, many users simply turn off or otherwise disable malware scanning, which can leave users unprotected.

### SUMMARY

Embodiments of a data processing apparatus and associated computer-executed method are adapted for federated scanning of multiple computers. The data processing apparatus comprises a logic that controls scanning among a plurality of data objects distributed among a plurality of distributed electronic data storage systems. The logic maintains a data set of paired location identifiers and intrinsic references corresponding to individual data objects of the plurality of data objects and controls scanning so that redundant scanning of duplicate data objects with matching intrinsic references occurring in multiple locations is avoided.

### BRIEF DESCRIPTION OF THE DRAWINGS

Embodiments of the invention relating to both structure and method of operation may best be understood by referring to the following description and accompanying drawings:

FIG. 1 is a schematic block diagram showing an embodiment of a data processing apparatus that is adapted for federated scanning of multiple computers;

FIG. 2 is a schematic block diagram depicting an embodiment of a system configured for federated scanning of multiple computers;

FIG. 3 is a schematic block diagram showing an embodiment of an article of manufacture that implements a technique for federated scanning of multiple computers;

FIG. 4 is a schematic block diagram illustrating an embodiment of a data processing apparatus that is adapted for federated scanning of multiple computers;

FIG. 5 is a schematic block diagram depicting another embodiment of an article of manufacture that implements a technique for federated scanning of multiple computers;

FIGS. 6A and 6B are flow charts illustrating one or more embodiments or aspects of a computer-executed method for federated scanning of multiple computers; and

FIG. 7 is a schematic block diagram depicting an embodiment of architecture for a data processing system 700 that efficiently manages background data analysis.

### DETAILED DESCRIPTION

A technique for performing scanning with less performance impact than current methods (scanning every item on every machine upon which the item appears) is desired.

One technique for reducing performance impact of scanning involves synchronizing the contents of the computers to be scanned with central servers and then performing the scan on the servers instead of the computers. Intrinsic references can be used to avoid scanning any given item more than once. However, the approach may involve usage of extra storage and processing resources (for example, the central servers) and may have problems when privacy restrictions, for example European privacy laws, prevent moving data off of the original machines.

The technique of synchronizing contents of the computers on the server before scanning can be improved by leaving the data in place on the computers and exporting intrinsic references for the data from the computers to the server, rather than exporting data on the computers to be scanned to central machines. The technique thus reduces scanning costs while keeping data on the computers, thus avoiding violation of European privacy laws. In the improved technique, the intrinsic references can be used to determine upon which computers each item occurs and enable scheduling of each item to be scanned only once. Scanning can be performed with load balancing so that work is spread, preferentially to idle or machines whose performance is less crucial, for example laptop computers.

Embodiments of systems and methods are disclosed which perform cooperative federated scanning of multiple computers.

By comparing the intrinsic references, for example cryptographic checksums, of the items on a number of machines to be scanned, scanning between the machines can be coordinated so that each item is scanned only once, saving resources and avoiding privacy problems due to moving data off home machines.

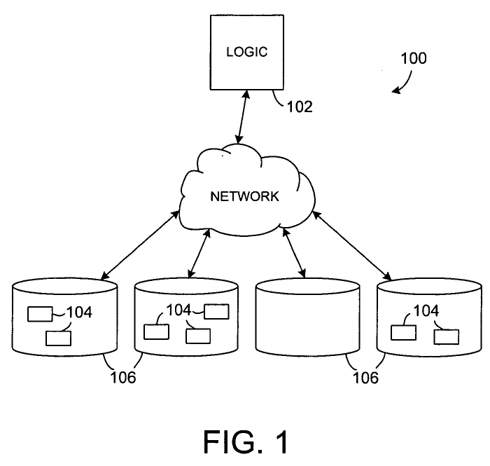

Referring to FIG. 1, a schematic block diagram illustrates an embodiment of a data processing apparatus 100 that is adapted for federated scanning of multiple computers. The data processing apparatus 100 comprises a logic 102 that controls scanning among a plurality of data objects 104 distributed among a plurality of distributed electronic data storage systems 106. The logic 102 maintains a data set of paired location identifiers and intrinsic references corresponding to individual data objects of the plurality of data objects 104 and controls scanning so that redundant scanning of duplicate data objects that have matching intrinsic references and occur in multiple locations is avoided.

An intrinsic reference is a computed reference for an item or group of items. In one example, an intrinsic reference can be computed by a hash function. In some implementations, the intrinsic reference can be based on a one-way hash so that the hash value produced by the hash function is irreversible and the original item cannot be reproduced based on the intrinsic reference. The intrinsic reference utilizes less storage capacity than the original item that the intrinsic reference identifies, so that more efficient usage of the logic 102 is enabled. In one example implementation, the intrinsic reference can be a recursive intrinsic reference, such as a root hash of a hash-based directed acyclic graph (HDAG).

An intrinsic reference, which can be generated by a client computer and/or by a monitoring server computer, creates a compact signature of an item with the properties that two items that differ in any way (at least a single bit is different between the two items) will have a different signature with high probability. Conversely, if two items are bit-wise identical, then the signature is identical regardless of where the items are stored. Typically, intrinsic references can be computed efficiently and stored more compactly than the items to which the intrinsic references refer. More generally, the term “reference” is used to refer to some identifier or indicator associated with an item that is capable of being scanned.

The logic 102 can balance load among the data objects 104 of the plurality of storage systems 106 wherein the logic preferentially schedules scanning of data objects 104 of distributed electronic data storage systems 106 that are idle or identified to perform less important operations so that cost of scanning is reduced or minimized. The logic 102 can schedule scanning to allocate workload based on one or more conditions such as current execution burden, computational power, connectivity, resource availability of a target device, and the like.

For example, scanning can be scheduled to avoid requiring too much work from machines that are actively occupied by execution of other tasks or are underpowered. For example, considerations of efficient usage of resources lead to a preference to scan a version of a file on a desktop PC rather than a corresponding laptop. Scheduling can also take into account that some machines are not always connected to the network or powered. The architecture disclosed herein permits scanning of disconnected machines (the scheduling phase does require connectivity), but the results can be delayed compared to another machine that is connected. If receipt of scanning results as soon as possible is important, scanning of connected machines is preferred.

In one embodiment, logic 102 can scan among the plurality of data objects 104 distributed among multiple distributed electronic data storage systems 106, analyze scan results, and initiate an action based on the scan results. Actions can include reporting viruses, removing data objects infected with a virus, quarantining files, generating reports, compiling scan information into a report or database for use with subsequent queries, and others.

In some applications and conditions, the logic 102 can optionally and selectively divide files into segments each of which is scanned separately.

In many cases, the useful unit of scanning is an entire file. However, in some cases files can be divided into overlapping pieces, each of which can be scanned separately, to promote efficiency and performance. The advantage of dividing a file is that a small change to a file may only change a few pieces, allowing only those pieces to be rescanned. For example, in the antivirus case rescanning an entire file is unnecessary when known that only a portion, for example 10 kB, of the data has changed. The case is easily handled by treating the pieces as items.

The logic 102 can maintain a list of intrinsic references that have been scanned and results of the scans so that subsequent scans of data objects on the list can be omitted.

The logic 102 can implement selective scanning wherein the system receives requests to scan particular sets of items, rather than assuming all items are considered for scanning.

For example, the scan can be assumed to be performed only once. In reality, scans usually are to be performed once per new item, wherein a changed item is considered to be a new item. Analysis machines or other storage devices can identify and recall which intrinsic references have already been scanned and the result of the scans. The information can be used to enable the analysis machines to avoid ever scheduling the already-scanned items to be scanned again.

The intrinsic references can be any suitable parameter that can identify the data objects 104. For example, the intrinsic references can be cryptographic hashes based on data in the data objects 104. A hash is any defined procedure or mathematical function for converting data into a relatively small integer, which can be called a hash value, hash code, hash sum, hash, or the like.

The logic 102 can coordinate among multiple different scan types to perform scans only once per data object. Thus, a system can be responsible for multiple types of scans, each of which is to be performed once per item. For example, in an antivirus system, scanning for each particular virus can be considered a different scan.

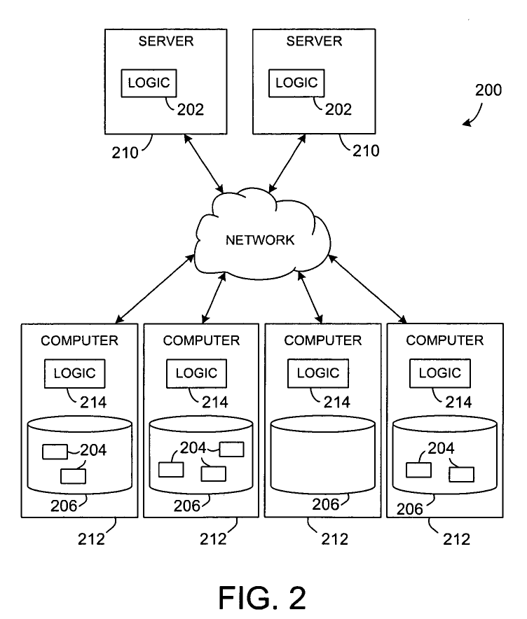

Referring to FIG. 2, a schematic block diagram illustrates an embodiment of a system 200 configured for federated scanning of multiple computers. The system 200 includes logic 202 that controls scanning among multiple data objects 204 distributed among distributed electronic data storage systems 206. The logic 202 maintains a set of paired location identifiers and intrinsic references corresponding to individual data objects and controls scanning so that duplicate data objects with matching intrinsic references occurring in multiple locations can be scanned only once.

The system 200 further comprises one or more servers 210 that execute the logic 202 which receives paired location identifiers and intrinsic references from systems of the plurality of distributed electronic data storage systems 206. For duplicate data objects with matching intrinsic references, the logic 202 schedules which of the distributed electronic data storage systems 206 is to execute the scan and when the scan is to be executed.

The system 200 can further comprise a plurality of computers 212 including the plurality of distributed electronic data storage systems 206. Individual computers of the plurality of computers 212 can include logic 214 that computes an intrinsic reference for data objects for which a copy somewhere on the system 200 is to be scanned, identifies location of the data objects, and sends a paired location identifier and intrinsic reference to one of the servers for maintaining the data set of paired location identifiers and intrinsic references.

The one or more servers 210 can be in the form of at least one analysis machine, a single central computer, a peer-to-peer network, a peer-to-peer network comprising the plurality of computers wherein a distributed hash table is used to distribute the data set of paired location identifiers and intrinsic references, and the like.

An illustrative embodiment of the system 200 can include a series of machines, M1, M2, . . . , Mn to be scanned (computers 212). Each machine can compute an intrinsic reference for each item of data that machine holds that is to be scanned. Each machine then sends pairs including identification of a machine name and an intrinsic reference to one or more analysis machines (for example server or servers 210). All the pairs with the same intrinsic reference are communicated to the same analysis machine, but pairs with different intrinsic references may go to different analysis machines.

The analysis machine or machines 210 may be a single central computer or a peer-to-peer network, possibly composed of the original machines M1, M2, . . . , Mn. In the later case, a distributed hash table (DHT) may be used to distribute the pairs.

Once the pairs have been distributed, the analysis machines schedule which machine should scan each item. The analysis machines then inform the original machines of which items the machines are to scan. The scheduling decision can be delayed to give more time for data to become replicated in the system, which may increase the scheduling options and flexibility. At one extreme, scheduling decisions can be delayed until the metadata generated by a scan is requested. Once scheduled, scanning can proceed in a normal or usual manner.

Actions can be taken based on the scan results such as reporting viruses, applying quarantine to machines, generating reports, and the like. Items that are present on multiple computers may require the same actions to be taken on each of the machines that the item appears. For example, upon detection of a virus in one machine, identical items on multiple machines indicate the presence of the virus on all of the multiple machines so that all infected items are removed.

Information obtained from the scans can be compiled into a report or database for use with future queries. Otherwise, the information can be maintained locally, also for use in answering future queries, for example Google desktop.

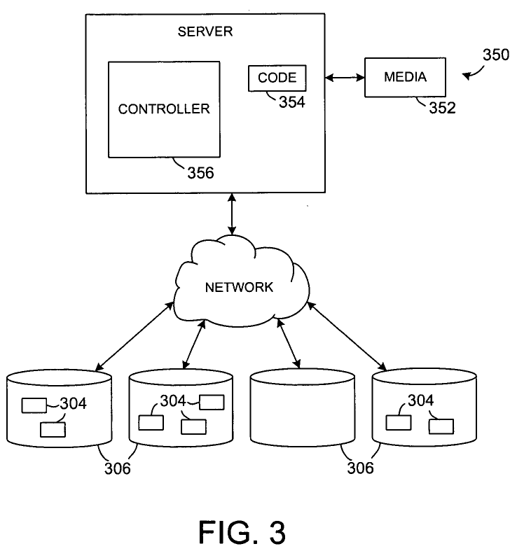

Referring to FIG. 3, a schematic block diagram depicts an embodiment of an article of manufacture 350 that implements a technique for federated scanning of multiple computers. The illustrative article of manufacture 350 comprises a controller-usable medium 352 having a computer readable program code 354 embodied in a controller 356 for managing data. The computer readable program code 354 causes the controller 356 to control scanning among a plurality of data objects 304 distributed among a plurality of distributed electronic data storage systems 306. The program code 354 further causes the controller 356 to maintain a data set of paired location identifiers and intrinsic references corresponding to ones of the plurality of data objects, and to control scanning wherein redundant scanning of duplicate data objects with matching intrinsic references occurring in multiple locations is avoided.

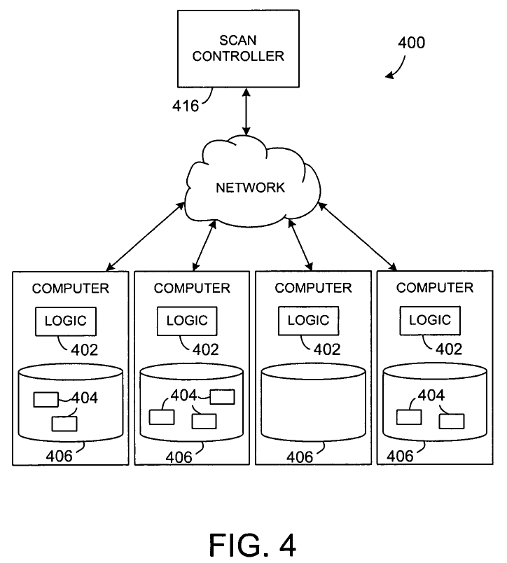

Referring to FIG. 4, a schematic block diagram illustrates an embodiment of a data processing apparatus 400 that is adapted for federated scanning of multiple computers. The data processing apparatus 400 comprises a logic 402 that is executable in an electronic data storage system 406 of multiple distributed electronic data storage systems 406. The logic 402 computes intrinsic references for data objects 404 to be scanned, identifies location of the data objects 404, and sends paired location identifiers and intrinsic references to a scan controller 416 that controls scanning among a plurality of data objects 404 distributed among the plurality of distributed electronic data storage systems 406. The logic 402 controls scanning so that redundant scanning of duplicate data objects with matching intrinsic references occurring in multiple locations is avoided.

The logic 402 computes the intrinsic references as cryptographic hashes that uniquely identify data in the data objects.

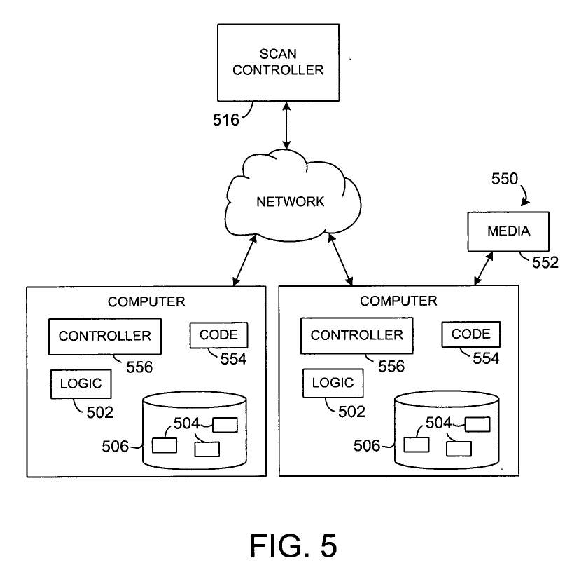

Referring to FIG. 5, a schematic block diagram depicts another embodiment of an article of manufacture 550 that implements a technique for federated scanning of multiple computers. The depicted article of manufacture 550 comprises a controller-usable medium 552 having a computer readable program code 554 embodied in a controller 556 for managing data. The computer readable program code 554 causes the controller 556 to control scanning among a plurality of data objects 504 distributed among a plurality of distributed electronic data storage systems 506, compute intrinsic references for a data objects 504 to be scanned, and identify location of the data objects 504. The program code 554 further causes the controller 556 to send paired location identifiers and intrinsic references to a scan controller 516 that controls scanning among a plurality of data objects 504 distributed among the plurality of distributed electronic data storage systems 506. The logic 502 controls scanning so that redundant scanning of duplicate data objects 504 with matching intrinsic references occurring in multiple locations is avoided.

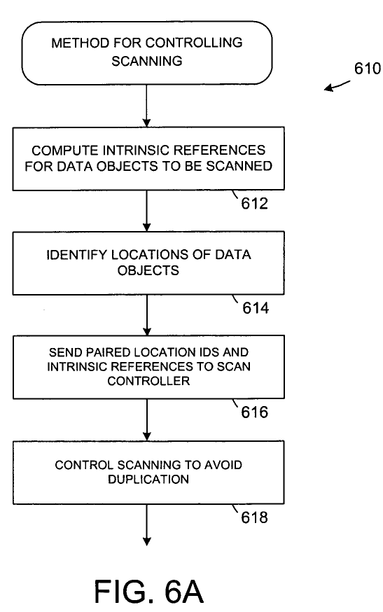

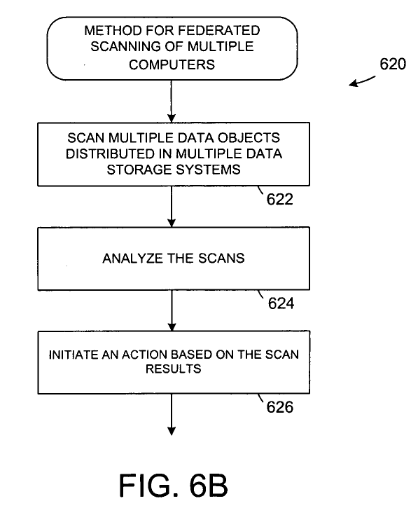

Referring to FIGS. 6A and 6B, flow charts illustrate one or more embodiments or aspects of a computer-executed method for federated scanning of multiple computers. A computer-executed method for managing data among a plurality of distributed electronic data storage systems can include several operations that execute concurrently or separately. The method comprises controlling scanning among the plurality of data objects distributed among the plurality of distributed electronic data storage systems and maintaining a data set of paired location identifiers and intrinsic references corresponding to ones of the plurality of data objects. Scanning is controlled so that redundant scanning of duplicate data objects with matching intrinsic references occurring in multiple locations is avoided.

Referring to FIG. 6A, in some embodiments a method 610 for controlling scanning can further comprise computing 612 intrinsic references for data objects to be scanned, and identifying 614 locations of the data objects. A paired location identifier and intrinsic reference are sent 616 to a scan controller that controls scanning among a plurality of data objects distributed among the plurality of distributed electronic data storage systems. Scanning is controlled 618 so that redundant scanning of duplicate data objects with matching intrinsic references occurring in multiple locations is avoided.

Referring to FIG. 6B, an embodiment of a method 620 for federated scanning of multiple computers can further comprise scanning 622 among the plurality of data objects distributed among a plurality of distributed electronic data storage systems, and analyzing 624 the scans. One or more selected action can be initiated 626 based on scan results. Example actions include reporting viruses, removing data objects infected with a virus, quarantining one or more of multiple distributed electronic data storage systems, generating reports, compiling scan information into a report or database for use with subsequent queries, and the like.

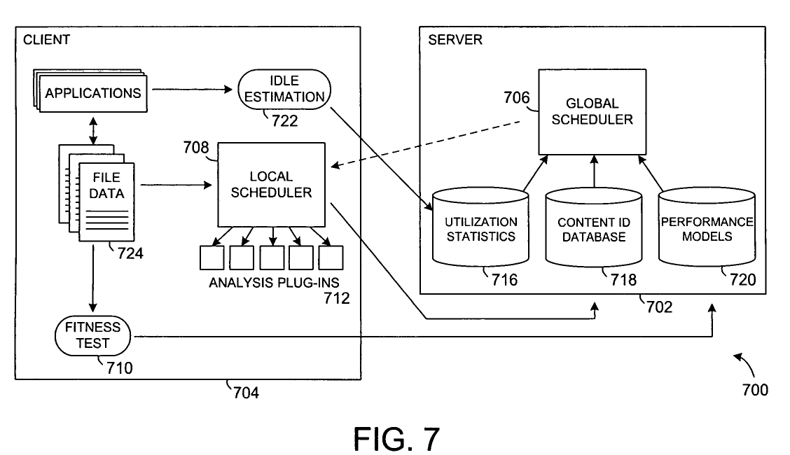

Referring to FIG. 7, a schematic block diagram depicts an embodiment of architecture for a data processing system 700 that efficiently manages background data analysis. The illustrative system 700 exploits the fact that data in an enterprise is often replicated to efficiently schedule background data analyses. The system 700 uses content hashing to identify duplicate content, and scans each unique piece of content only once. The system 700 can delay scheduling of scans to increase the likelihood that the content will be replicated on multiple machines, thus providing more choices for where to perform the scan. Furthermore, the system 700 can prioritize machines to maximize use of idle time and minimize the impact on foreground activities.

The system 700 operates as an enterprise-wide analysis infrastructure based on two-phased scanning. In the first phase of two-phase scanning, data to be analyzed is assigned a unique content hash, which is supplied to a global scheduler 706 for duplicate detection. The scheduler 706 delays work for a specified interval, giving the system 700 time to create replicas or potentially remove the data entirely from the system 700 (obviating the need to perform analysis at all). After the delay period, the scheduler 706 initiates the second phase of scanning on a single machine containing a replica of the data. By running costly content analysis routines on each unique piece of content only once, the amount of work in the system 700 is reduced. Furthermore, system 700 uses models of client performance, client idle time, and specified client priorities to minimize the impact on foreground workloads and perform load-shedding from the busiest system clients.

In an illustrative embodiment, the system 700 includes a client-server data analysis infrastructure that minimizes the impact of background analysis tasks on foreground workloads. The system 700 can consider all of the data across the enterprise, analyzing each unique piece of content only once and effectively balancing the load of analysis with the impact on foreground workloads. The system 700 enables administrators to specify the desired freshness of analysis, which ensures that analysis occurs within a specified period of time from the initial creation of the content. The opportunity to defer analysis to some future point increases the likelihood that additional replicas will be available, enabling more alternatives for scanning and increasing the likelihood that short-lived data will be deleted, reducing the overall amount of work to be done. The unified local scanning infrastructure maximizes efficiency by running multiple analyses in parallel and efficiently scheduling I/O.

Scanning occurs in a two-phased manner. In phase one, the local scheduler 708 identifies all of the new and modified data on the client 704 and calculates a unique content ID, or CID, for each piece of data using a hash of the data, for example a SHA-1 hash. The set of all new CIDs are then uploaded to a content ID database 718 in the server 702.

At the beginning of each scheduling period, the global scheduler 706 identifies all of the CIDs in the system 700 that have met a predetermined freshness target and marks the identified CIDs as eligible. The global scheduler 706 then chooses one client in the system that holds each CID to run the analysis routines on that data. The choice decision is based on estimates of client idle time 722 (determined either through utilization statistics 716 or specified by an administrator) and a performance model 720 (determined through a fitness test 710) to estimate the resources used for the analysis on the client 704.

In phase two, the local scheduler 708 receives a set of content references (including the CIDs, CID locations and file types) from the server 702 of content to analyze. The local scheduler 708 locates copies of the CIDs and schedules the analyses for execution. Once the analysis is complete, the local scheduler 708 notifies the central server 702, sending any relevant results. If the CID is no longer available on the client 704, the local scheduler 708 notifies the global scheduler 706, which reschedules the work on another client, or removes the work if no client holds a copy of the data.

At the global level, central server 702 chooses which clients 704 run the analysis routines on which data at what time. The decision of delay is limited by the assigned freshness, how long the system 700 can wait before performing analysis. The decision of placement of the analysis is limited by the inter-machine replication for each item that is scanned, which determines the set of clients that are chosen to perform analysis.

Conventional scanners run using an immediate freshness guarantee wherein when an item is changed, each analysis routine is re-run immediately on the item. Furthermore, individual scanners don't take advantage of inter-machine (or intra-machine) replication, repeating work on each copy of the data throughout the enterprise. The conventional immediate freshness guarantee is baseline global scheduling decision which can be called “immed-all”.

The system 700 disclosed herein uses two-phase scanning to provide the global scheduler with identification of which clients contain which content, thereby limiting the analysis to a single client for each unique piece of content and minimizing the amount of work done throughout the system 700. However, identification of the client says nothing of placement.

If placement decisions are made immediately when new content is found, then the first client to report the new content becomes responsible for the analysis, a behavior that does nothing to assist clients with little idle time in which to perform analysis because, if the client is the first to report, the client is still burdened with the work. The system 700 solves this problem by introducing the freshness delay period between the first and second phases of scanning. Delaying work increases the likelihood that additional replicas will arrive at the server 702, increasing the scheduling options. Delaying work also increases the likelihood that short-lived data will be deleted, reducing the amount of work to be done. The option to delay produces two families of global scheduling policies, which can be called “immed and delay”.

The option of the system 700 to schedule work on one of several clients enables the usage of two factors, idle time and priority (impact tolerance) class, to make decisions. Each client 704 in the system 700 supplies a model of available idle time during each scheduling period, as well as a specified priority class. A client's priority class is an indication of tolerance to impact on foreground workload of the client. Higher priority machines have higher tolerance to impact, so clients will always shed work that exceeds the idle time to clients of higher priority classes when possible. For example, in an environment with two machine classes, desktop and laptop, impacting the foreground workload on the desktop is preferred over the laptop. As a result, desktops would be assigned higher priority than laptops. Performance is substantially improved by creating impact on a higher priority class.

Using client performance models, the system 700 determines the time expected for each client to perform the analysis. Using the expected time of each client, the system 700 can then determine whether the analysis would fit within that client's available idle time for the scheduling period. Clients 704 with sufficient idle time for the analysis are considered idle, and the rest busy. The system 700 chooses the idle client from the highest possible priority class with the most available idle time. If no idle clients exist, the system 700 chooses the busy client from the highest priority class that is least exceeding the idle time threshold, defining a scheduling algorithm that can be called a “delayed idle priority-worst-fit scheduler”.

To further improve load balancing, the system 700 batches the scheduling of eligible content into scheduling periods. Eligible content is defined as that which is qualified with a specified delay period. At the beginning of the period, the system 700 orders the eligible content based on the priority classes of the clients that contain replicas of the content. Specifically, the system 700 assigns each CID an M-digit ordering number of N-ary digits, where M is the number of priority classes ordered from highest to lowest and N is the number of clients in the system 700. The digit is assigned based on the number of replicas of that CID exist in each priority class. The system 700 then sorts the CIDs by ordering number from lowest to highest, then schedules the work for each piece of content using the idle-priority-worst-fit scheduler. For example, with three priority classes A>B>C, a CID with two replicas on A machines and one replica on C machines would have an ordering number of (2, 0, 1). A second CID with a single replica on a C machine and with ordering number (0, 0, 1), would be scheduled before the first CID, defining a policy which can be called “delayed ordered-idle-priority-worst-fit scheduler”, or delay-O-IP-W.

The system's combination of two-phase scanning, analysis delay, and delay-O-IP-W scheduler enables improvements over the traditional “immed-all” policy. First, the combination of capabilities minimizes global work by scanning each unique piece of content only once. Second, the technique enables balancing of work across the system by scheduling analysis work on the most appropriate client to maximize use of idle time and minimize the impact on foreground workloads.

The delay-O-IP-W algorithm includes five factors: (1) the decision to delay work (delay), (2) the decision to order work (O), (3) the decision to consider idle time (I), (4) the decision to consider priorities (P), and (5) the decision to choose among clients using worst-fit (W). In some conditions or implementations, alternate factors can be considered including immediate (immed) analysis instead of delayed, random (R) instead of ordered scheduling of work, ignoring idle time (N), equal priorities (E), and random (R) client selection instead of worst-fit.

The local scheduler 708 centralizes the decisions of what to analyze, when to analyze, and the schedule of analysis routines to run. The approach of the local scheduler 708 parallelizes analyses that might otherwise be run sequentially on a piece of content, and minimizes the I/O overheads associated with scanning.

The client 704, when started, is supplied a set of local files that are to be analyzed. The file set 724 is supplied either through change detection routines, which request phase one metadata (such as content hash, size and file type), or by the central server 702, which requests phase two metadata (such as keyword vectors, similarity summary). The local scheduler 708 executes the requested analyses in parallel. The client 704 prefetches files from the disk and fills a one-to-many producer/consumer buffer that feeds the scheduled analysis routines. The approach ensures that only a single pass of the data is required.

The global scheduling algorithms execute using information including specifications of client priorities, idle times, and performance models. While the first two can be specified by an administrator, performance models are generated through a fitness test 710 that is designed to supply the system 700 with an estimate of expected time to perform analysis on data of a given size.

The system 700 determines a plug-in resource performance model using a fitness test 710 that runs each analysis plug-in 712 in isolation on sets of files at each of multiple file sizes, producing a performance curve that determines each plug-in's average resource utilization at each file size. For sizes beyond a maximum size, performance is interpolated and extrapolated to calculate per-byte resource utilization. The analysis plug-ins are programming extensions that interact with a host application to supply on-demand functionality.

The system 700 enables several aspects of improved performance. First, the system 700 enables improved local scanning performance by multiple times over naive scanning. Second, the global scheduler 706 effectively exploits the replication present in the dataset to reduce the total work done. Third, the system 700 can relieve the load on the most burdened clients, reducing the work performed and impact on their foreground activity.

Two-phase scanning can potentially reduce impact on foreground workloads by reducing work and providing opportunities for load balancing so long as replicas are available. For example, if no replicas exist in the system then two-phase scanning increases the total work by adding the computation of a content hash above that of the analysis.

Terms “substantially”, “essentially”, or “approximately”, that may be used herein, relate to an industry-accepted tolerance to the corresponding term. Such an industry-accepted tolerance ranges from less than one percent to twenty percent and corresponds to, but is not limited to, functionality, values, process variations, sizes, operating speeds, and the like. The term “coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. Inferred coupling, for example where one element is coupled to another element by inference, includes direct and indirect coupling between two elements in the same manner as “coupled”.

The illustrative block diagrams and flow charts depict process steps or blocks that can be executed as logic in programming that executes in a computer, controller, state machine, and the like as programmed, and may represent modules, segments, or portions of code that include one or more executable instructions for implementing specific logical functions or steps in the process. Although the particular examples illustrate specific process steps or acts, many alternative implementations are possible and commonly made by simple design choice. Acts and steps may be executed in different order from the specific description herein, based on considerations of function, purpose, conformance to standard, legacy structure, and the like.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, and dimensions are given by way of example only. The parameters, materials, and dimensions can be varied to achieve the desired structure as well as modifications, which are within the scope of the claims. Variations and modifications of the embodiments disclosed herein may also be made while remaining within the scope of the following claims.

What is claimed is:

1. A data processing apparatus comprising:
a logic that controls scanning among a plurality of data objects distributed among a plurality of distributed electronic data storage systems, the logic maintaining a data set of paired location identifiers and intrinsic references corresponding to ones of the plurality of data objects and controlling scanning wherein redundant scanning of duplicate data objects that have matching intrinsic references and occur in multiple locations is avoided.

2. The data processing apparatus according to claim 1 further comprising:
the logic load balancing among the plurality of storage systems data objects wherein the logic preferentially schedules scanning of data objects of distributed electronic data storage systems that are idle or identified to perform less important operations wherein cost of scanning is reduced or minimized, the logic scheduling scanning to allocate workload based on at least one condition selected from a group consisting of current execution burden, computational power, connectivity, and resource availability of a target device.

3. The data processing apparatus according to claim 1 further comprising:
the logic that scans among the plurality of data objects distributed among a plurality of distributed electronic data storage systems, analyzes scan results, and initiates an action based on the scan results, the action selected from among a group of actions consisting of reporting viruses, removing data objects infected with a virus, quarantining ones of the plurality of distributed electronic data storage systems, generating reports, and compiling scan information into a report or database for use with subsequent queries.

4. The data processing apparatus according to claim 1 further comprising:
the logic optionally and selectively dividing files into segments, each of which is scanned separately.

5. The data processing apparatus according to claim 1 further comprising:
the logic maintaining a list of intrinsic references that have been scanned and results of scans wherein subsequent scans of data objects on the list can be omitted.

6. The data processing apparatus according to claim 1 further comprising:
the logic coordinating among multiple different scan types to perform scans only once per data object.

7. The data processing apparatus according to claim 1 wherein:
the intrinsic references are cryptographic hashes based on data in referenced data objects.

8. The data processing apparatus according to claim 1 further comprising:
Claim a plurality of computers comprising ones of the plurality of distributed electronic data storage systems, ones of the plurality of computers comprising logic that computes an intrinsic reference for data objects that are to be scanned, identifies location of the data objects, and sends a paired location identifier and intrinsic reference to the at least one server for maintaining the data set of paired location identifiers and intrinsic references.

9. The data processing apparatus according to claim 1 further comprising:
at least one server that executes the logic receiving paired location identifiers and intrinsic references from ones of the plurality of distributed electronic data storage systems, the logic scheduling for duplicate data objects with matching intrinsic references which of the distributed electronic data storage systems is to execute the scan and when the scan is to be executed.

10. The data processing apparatus according to claim 9 further comprising:
the at least server selected from a group consisting of at least one analysis machine, a single central computer, a peer-to-peer network, a peer-to-peer network comprising the plurality of computers wherein a distributed hash table is used to distribute the data set of paired location identifiers and intrinsic references.

11. The data processing apparatus according to claim 1 further comprising:
an article of manufacture comprising:
a controller-usable medium having a computer readable program code for managing data, the computer readable program code further comprising:
code causing the controller to control scanning among a plurality of data objects distributed among a plurality of distributed electronic data storage systems;
code causing the controller to maintain a data set of paired location identifiers and intrinsic references corresponding to ones of the plurality of data objects; and
code causing the controller to control scanning wherein redundant scanning of duplicate data objects with matching intrinsic references occurring in multiple locations is avoided.

12. A data processing apparatus comprising:
a logic executable in a electronic data storage system of a plurality of distributed electronic data storage systems that computes intrinsic references for a data objects to be scanned, identifies location of the data objects, and sends paired location identifiers and intrinsic references to a scan controller that controls scanning among a plurality of data objects distributed among the plurality of distributed electronic data storage systems wherein redundant scanning of duplicate data objects with matching intrinsic references occurring in multiple locations is avoided.

13. The data processing apparatus according to claim 12 wherein:
the logic computes the intrinsic references as cryptographic hashes that uniquely identify data in the data objects.

14. The data processing apparatus according to claim 12 further comprising:
an article of manufacture comprising:
a controller-usable medium having a computer readable program code embodied in a controller for managing data, the computer readable program code further comprising:
code causing the controller to control scanning among a plurality of data objects distributed among a plurality of distributed electronic data storage systems;
code causing the controller to compute intrinsic references for a data objects to be scanned;
code causing the controller to identify location of the data objects; and
code causing the controller to send paired location identifiers and intrinsic references to a scan controller that controls scanning among a plurality of data objects distributed among the plurality of distributed electronic data storage systems wherein redundant scanning of duplicate data objects with matching intrinsic references occurring in multiple locations is avoided.

15. A controller-executed method for managing data among a plurality of distributed electronic data storage systems comprising:
controlling scanning among a plurality of data objects distributed among the plurality of distributed electronic data storage systems;
maintaining a data set of paired location identifiers and intrinsic references corresponding to ones of the plurality of data objects; and
controlling scanning wherein redundant scanning of duplicate data objects with matching intrinsic references occurring in multiple locations is avoided.

16. The method according to claim 15 further comprising:
computing an intrinsic reference for data objects to be scanned;
identifying location of the data objects; and
sending a paired location identifier and intrinsic reference to a scan controller that controls scanning among the plurality of data objects distributed among the plurality of distributed electronic data storage systems.

17. The method according to claim 15 further comprising:
scanning among the plurality of data objects distributed among a plurality of distributed electronic data storage systems;
analyzing the scans; and
initiating at least one selected action based on scan results, the actions in a group consisting of:
reporting viruses;
removing data objects infected with a virus;
quarantining ones of the plurality of distributed electronic data storage systems;
generating reports; and
compiling scan information into a report or database for use with subsequent queries.
